(19) United States
(12) Patent Application Publication
(10) Pub. No.: US 2008/0067356 A1
(43) Pub. Date: Mar. 20, 2008

(54) Ionization of neutral gas-phase molecules and mass calibrants

(76) Inventors: Paul C. Goodley, Cupertino, CA (US); Harry F. Prest, Santa Cruz, CA (US); Christine A. Miller, Campbell, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/523,963

(22) Filed: Sep. 20, 2006

(51) Int. Cl. H01J 49/04

(52) U.S. Cl. 250/288

(57) ABSTRACT

An apparatus for ionizing an analyte sample with a mass calibrant is provided. The apparatus includes an ionization chamber defining an ionization region, a first passageway coupled to the ionization region for delivering the analyte sample to the ionization region, a second passageway leading to a mass analyzer having an orifice arranged adjacent to the ionization region to receive ions from the ionization region, a third passageway coupled to the ionization chamber at a first end and having a second end with an orifice arranged to receive gaseous neutral mass calibrant molecules, and an ionization device arranged within the ionization chamber. The ionization device generates primary ions from the analyte sample, and the primary ions ionize a portion of the gaseous neutral mass calibrant molecules received into the ionization region via the third passageway.

### BACKGROUND INFORMATION

Analyte samples can be delivered to an ionization source of a mass spectrometer in a variety of forms, in solid, liquid and gaseous phases. When analytes are provided in liquid and gaseous phases, they are typically sorted by chromatography, either high performance liquid chromatography (HPLC) for liquid analytes, or gas chromatography (GC) for gas analytes. Separation of analyte molecules allows the mass spectrometer downstream to evaluate the analyte molecules sequentially so that they can be more easily scanned in a mass analyzer.

Chromatography requires specialized instrumentation, such as separation columns, and an appropriate interface to an ionization source. Moreover, the chromatography separation process often takes an hour or more to complete. The instrumentation may not be available outside of the laboratory context and the duration of the separation process may be an inconvenience when it is desired to identify a trace substance quickly. As an example, at a location where it is believed that a small, but possibly dangerous level of a toxic substance has been released into the atmosphere, it would be desirable to analyze a sample of ambient air at the location for the toxic substance directly, without necessarily having to pass the sample through a chromatography apparatus.

### SUMMARY OF THE INVENTION

The present invention facilitates rapid and convenient detection of trace substances in a sample by providing an apparatus that receives gas-borne neutral sample molecules directly through an inlet, dispensing with the need for a specialized interface or chromatographic separation.

In a first aspect, the present invention provides an apparatus for ionizing an analyte sample with a mass calibrant that comprises an ionization chamber defining an ionization region, a first passageway coupled to the ionization region for delivering the analyte sample to the ionization region, a second passageway leading to a mass analyzer having an orifice arranged adjacent to the ionization region to receive ions from the ionization region, a third passageway coupled to the ionization chamber at a first end and having a second end with an orifice arranged to receive gaseous neutral mass calibrant molecules, and an ionization device arranged within the ionization chamber. The ionization device generates primary ions from the analyte sample and the primary ions ionize a portion of the gaseous neutral mass calibrant molecules received into the ionization region via the third passageway.

In another aspect, the present invention provides an apparatus for ionizing molecules from a sample that comprises an ionization chamber defining an ionization region, a first passageway coupled to the ionization region for delivering a primary material to the ionization chamber, a second passageway having an orifice arranged adjacent to the ionization region to receive ions from the ionization region, a third passageway coupled to the ionization chamber at a first end and having a second end with an orifice arranged to receive gaseous neutral molecules derived from the sample, and an ionization device arranged within the ionization chamber. The ionization device generates primary ions from the primary material provided via the first passageway to the ionization region, the primary ions ionizing a portion of the gaseous neutral molecules received into ionization region via the third passageway.

In yet another aspect, the present invention provides a mass spectrometry system for analyzing an analyte sample with a mass calibrant. The system comprises an apparatus that includes: an ionization chamber defining an ionization region, a first passageway coupled to the ionization region for delivering the analyte sample to the ionization region, a second passageway leading to a mass analyzer having an orifice arranged adjacent to the ionization region to receive ions from the ionization region, a third passageway coupled to the ionization chamber at a first end and having a second end with an orifice arranged to receive gaseous neutral mass calibrant molecules, and an ionization device arranged within the ionization chamber, the ionization device generating primary ions from the analyte sample, the primary ions ionizing a portion of the gaseous neutral mass calibrant molecules received into the ionization region via the third passageway. The system further includes a mass analyzer coupled to the downstream end of the second passageway and a detector situated downstream from the mass analyzer.

In yet another aspect, a method of ionizing molecules received from a sample situated external to an ion source is provided. The method comprises providing primary ions in an ionization region within the ion source through a primary passageway, receiving gaseous neutral molecules from the external sample into the ionization region within the ion source via a secondary passageway, a portion of the gaseous neutral molecules from the external sample being ionized by interaction with the primary ions within the ionization region, and guiding the primary ions and ions derived from the external sample to an inlet of a mass spectrometer.

The teachings herein can also be usefully applied to mass calibration of mass spectrometry systems. A method of calibrating a mass spectrometry system is provided which includes providing analyte ions in an ionization region within the ion source, receiving gaseous neutral mass calibrant molecules from a external source into the ionization region, a portion of the neutral mass calibrant molecules being ionized by interaction with the analyte ions produced in the ionization region, directing both mass calibrant ions and analyte ions downstream into the mass analyzer, and detecting the analyte ions and the mass calibrant ions in the mass analyzer.

The present invention also provides an apparatus for providing a mass calibrant sample to an ion source having a first passageway for receiving an analyte sample, a second passageway leading downstream to a mass spectrometer and a third passageway for receiving a mass calibrant. The apparatus comprises a chamber having an opening for receiving a mass calibrant sample, a first orifice adapted to be coupled to the third passageway leading to the ion source and a second orifice adapted to be coupled to a source of gas flow and a restriction valve coupled to the first orifice of the chamber adapted to limit gas flow from the chamber toward the ion source.

### BRIEF DESCRIPTION OF THE DRAWINGS

FIG. 1 is a schematic illustration of an ionization apparatus according to the present invention coupled to a mass spectrometer.

FIG. 2 shows another embodiment of an ionization apparatus according to the present invention.

FIG. 3 shows an application of the ion source according to the present invention in which a mass calibrant is ionized and introduced into a mass spectrometer according to the method of the present invention.

### DETAILED DESCRIPTION

It is initially noted that reference to a singular item herein includes the possibility that there are plural of the same items present. More specifically, as used herein and in the appended claims, the singular forms “a”, “an”, “said” and “the” include plural referents unless the context clearly dictates otherwise.

The term “adjacent” means near, next to or adjoining. Something adjacent may also be in contact with another component, surround (i.e. be concentric with) the other component, be spaced from the other component or contain a portion of the other component.

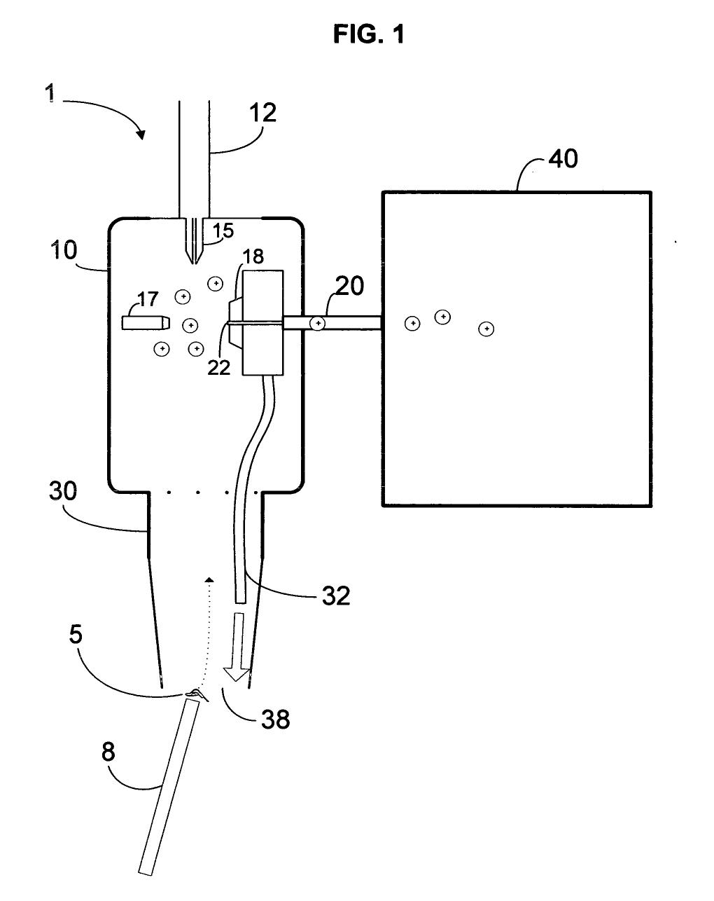

FIG. 1 schematically illustrates an example embodiment of an apparatus for ionizing a sample according to the present invention. As shown, the apparatus 1 is coupled to a mass spectrometer 40 for detection of extremely low levels of gas-borne molecules in the ambient environment.

The apparatus 1 includes an ionization chamber 10 that comprises an enclosure in which ions are generated. An ionization device 15, which may comprise an electrospray tip, for example, extends into (or is enclosed by) the ionization chamber 10 and generates primary ions by mechanisms well known in the art from a gas/liquid aerosol that is present within the ionization chamber or supplied to the ionization chamber via a first passageway 12. The primary ions may include ions generated from a neutral analyte sample delivered to the ionization chamber through the first passageway and/or ions generated from other reactive substances provided or present within the ionization chamber such as water (hydronium and hydroxyl ions) or ammonia in vapor or liquid form, beta particles, Ni⁶³, etc.

The space within the ionization chamber 10 in which primary ions are generated is termed the ionization region. It is noted that while electrospray is a particularly suitable ionization technique, other ionization modes can also be used to generate primary ions such as high-velocity gas impact, electron capture or impact and photoionization. The primary ions may be generated continuously or periodically during operation of the ionization device 15 to maintain a desired concentration of primary ions within the ionization region. A portion of the primary ions may be directed by electric fields towards an orifice 22 that leads downstream to a mass spectrometer 40 via a second passageway 20. However, the concentration of primary ions within the ionization region is maintained such that a sufficient number of primary ions can interact with neutral molecules as described below.

A third passageway 30 extends from the ionization chamber 10 and has an orifice 38 at its distal end. Gas-borne molecules can enter the apparatus 1 by entering the orifice 22 and diffusing through the length of the first passageway 30 into the ionization chamber 10. A sample 5 may thus be placed adjacent to coupled to the orifice 38 in order to introduce gas-borne neutral sample molecules into the ionization chamber 10 via such diffusion. In the example embodiment depicted, the sample in condensed phase is placed onto a sample support 8 (in solution or otherwise) positioned adjacent to the orifice 38. Volatilization and diffusion of neutral sample molecules may occur even though the sample 5 is prepared in condensed phase since some amount, albeit a small concentration thereof, is volatized from the sample at room temperature by evaporation or sublimation. Heat may also be applied to the sample 5 to promote volatilization and to speed up the ionization and detection process as will be discussed below. The concentration of gaseous neutral molecules that diffuse through the third passageway can be limited using plugged stoppers, microvalves, etc. (not shown) positioned within the third passageway 30.

In the depicted embodiment, the third passageway 30 may also serve as a passageway for the release of exhaust gases such as N₂ purge gas emanating from the apparatus 1 into the ambient atmosphere. In some embodiments, exhaust gases may be expelled through an exhaust conduit 32 that extends for some length in the third passageway 30. An interesting feature of the apparatus disclosed herein is that the flow of exhaust gas through the third passageway 30 does not eliminate the back diffusion of gaseous molecules in the opposite direction. It has been found that the length of the exhaust conduit 32 and the associated exhaust flow rate affects the rate of back diffusion from the environment into the ion source; greater vent lengths increase resistance and thus decrease the back diffusion rate, but do not affect the signal response.

When the gaseous neutral molecules diffuse through the length of the third passageway 30 into the ionization chamber 10 they pass into the ionization region and encounter primary ions present within the ionization region. A portion of the neutral molecules are ionized by charge transfer and possibly other electro-physical interactions with the primary ions. A neutral molecule [M] either obtains a proton though charge transfer with a positive (or negative) primary ion such as a hydronium ion:

M°+HA⁺→[M+H]⁺+A°

or the neutral molecule loses a proton through charge transfer with a negative primary ion such as a hydroxyl ion:

M°+HB⁻→[M−H]⁻+B°

It is emphasized that the charge transfer process whereby the neutral molecules are ionized by charge transfer with primary ions is a low-energy ‘soft ionization’ process in which energy interactions are typically on the order of 2-20 eV (electron volts). This is in contrast to ‘hard’ ionization techniques such as occur in Atmospheric Pressure Chemical Ionization (APCI) in which molecules are ionized by intense energy fields on the order of 100-1000 eV which are generated by corona discharge. By employing a soft ionization technique to produce secondary ions, ion suppression that can arise when dual ‘hard’ ionization sources are employed is largely avoided.

Once the neutral molecules derived from the sample are ionized in the ionization region they become subjected to an electric field produced in this region by the combined action of several electrodes 15, 17, 18 maintained at different voltages. The electric field guides the ions in the ionization region toward a low pressure region in front of the orifice 22 of the second passageway 20 that leads toward the mass spectrometer 40. In the example embodiment, a first electrode 15 is positioned above the ionization region, a second electrode 17 is positioned opposite the orifice of the second passageway 20, and a third electrode 18 is positioned adjacent to the orifice 22 of the second passageway. It is noted however, that the configuration of the electrodes 15, 17, 18 is merely exemplary and other configurations, and a different number of electrodes, may be employed to create electric fields suitable for directing ions in the ionization region toward the orifice 22 of the second passageway 20. Ions that reach the orifice 22 are pulled through into the second passageway by the pressure differential between the second passageway 20 and the ionization chamber 10.

Ions guided into the orifice 22 of the second passageway 20 are guided further downstream by pressure differentials, electrodes and other ion optics into the mass spectrometer 40, which may comprise any known mass analyzer devices, including but not limited to: quadrupole, ion trap (linear or two-dimensional), time-of-flight (TOF), orbitrap, and FT-ICR (Fourier Transform Ion Cyclotron Resonance) devices. The spectrometer may comprise single mass analyzer or a tandem (MS/MS) configuration including more than one mass analyzer arranged in sequence. The ions guided into the mass spectrometer 40 are filtered and detected within the mass spectrometer. A mass spectrum indicating abundance of detected ions according to mass/charge ratio is generated thereby.

One of the advantages of the above-described ion source and associated ionization method is that it is capable of providing extremely small concentrations of sample ions to the mass spectrometer that are detectable. If an extremely sensitive mass analyzer is employed, such as a time-of-flight (TOF), it is possible for sample levels on the order of 1 part per 10¹⁵ to be detected and identified.

### EXAMPLE

A sample of a known chemical having isotopic molecular weight of approximately 303 was introduced by way of the third passageway of an ionization apparatus according to the present invention. During monitoring the detected masses in scan mode at m/z of 304 (indicating the addition of a proton), the level detected increased whenever the sample was placed near the orifice, indicating that the chemical was diffusing into the apparatus against the exhaust flows and being ionized therein.

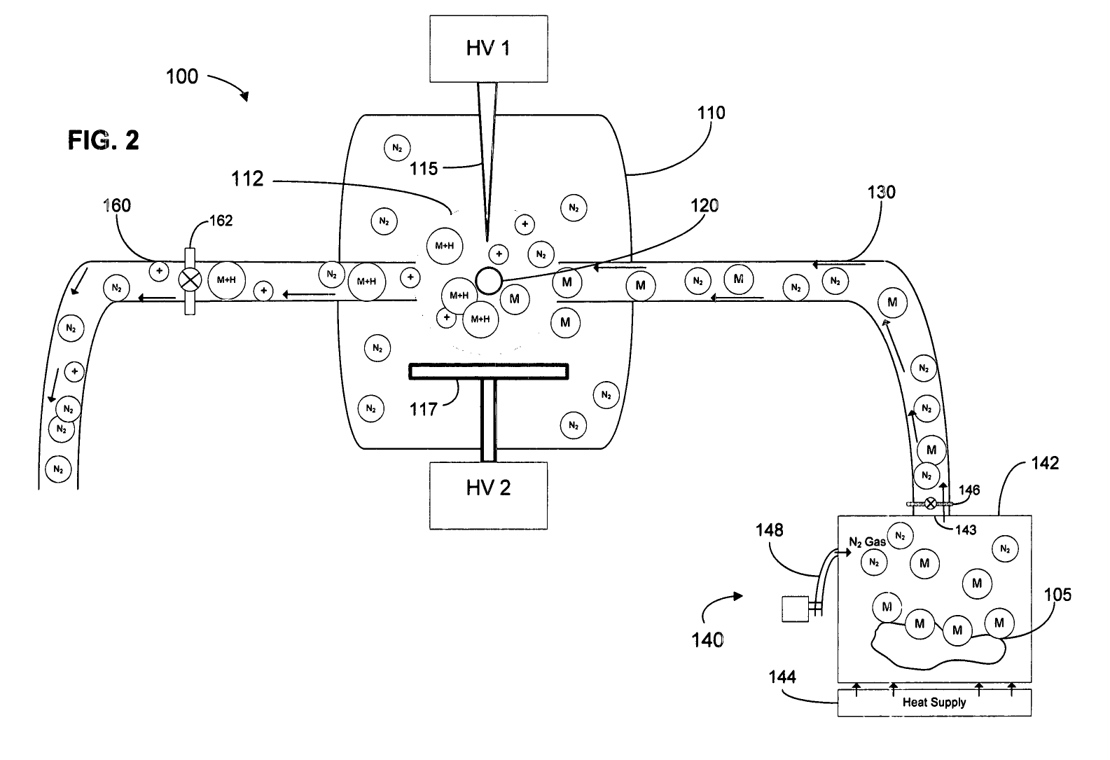

FIG. 2 shows another embodiment of an ion source according to the present invention. In this embodiment, the ion source provides a flow-through system in which heat may be applied to volatize a portion of a sample, and a slight gas flow facilitates the passage of volatized sample molecules into the ionization chamber.

As shown, the apparatus 100 includes an ionization chamber 110 having an ionization region 112 in which primary ions are generated. A first passageway (not depicted in FIG. 2; the first passageway would be coming from out of the page toward the ionization chamber) may be directly coupled to the ionization chamber to provide for input of substances from which the primary ions are generated, and a second passageway 120 leads toward a mass spectrometer, as in the embodiment depicted in FIG. 1. In the embodiment depicted in FIG. 2, the ions are generated by applying a high voltage generated by high-voltage power supply HV 1 to a primary electrode 115, which may comprise an electrospray tip. The ions generated in the ionization region by action of the primary electrode are denoted (+) and the gaseous molecules which have undergone charge transfer are denoted (M+H)+ in the figure.

One of the useful features of the embodiment depicted in FIG. 2 is the modular sample region 140 that conveniently supplies gaseous neutral molecules to the ionization chamber 110. The sample region 140 includes a sample chamber 142 which may comprise a housing or enclosure with hatch or door (not shown) that may be opened to place a sample 105 within the chamber and closed to protect the sample from contamination, and an exit orifice 143. A heating device 144 is coupled to or positioned adjacent to the chamber 142, preferably towards the bottom of the chamber near to where the sample is positioned. The heat generated by the device 144 is applied to the sample 105. Sufficient heat is supplied to volatize molecules on the surface of the sample 105. A low volume gas flow of nitrogen (or another inert gas at room temperature and typically at atmospheric pressure) on the order of about 0.1-10 liters per minute, may be introduced into the sample chamber 142 from an external gas source 148 to facilitate gas flow. A restriction valve 146 may be placed adjacent to the exit orifice 143 to restrict the flow of gaseous molecules out of the chamber 142

While a portion of the gaseous neutral molecules (M) released from the sample diffuse toward the exit orifice 143, the low volume gas flow enhances the egress of the gaseous molecules from the sample chamber 142 to a third passageway 130 coupled to the exit orifice 143. The third passageway 130 extends from the exit orifice 143 of the sample chamber 142 at a first end to the ionization region 112 within the ionization chamber 110 at its second end. As depicted, both gaseous sample molecules (M) and nitrogen molecules (N₂) flow through the third passageway 130 into the ionization region 112.

Within the ionization region, a portion of the sample molecules (M) encounter primary ions (HA+) and are ionized thereby, in this case taking on a proton and converting to positive ion (M+H)+ as discussed above. A substantial portion of the primary ions and secondary ions derived from the gaseous neutral molecules are guided into a low pressure region in front of an entrance to the second passageway 120 leading to a mass spectrometer by electric fields generated by electrodes 115, 117 coupled to respective power supplies HV 1, HV 2. The neutral molecules sample molecules (M) may constitute an unknown analyte sample to be determined, but in some applications (M) may instead comprise a source mass calibrant molecules of known mass.

To accommodate the low volume gas flow passed through the sampling region 140, the embodiment shown in FIG. 2 also includes an exit conduit 160 coupled on one end to the ionization region 112 across from the second (proximate) end of third passageway 130. A portion of the primary ions (+) and secondary ions (M+H)+ do not enter the second passageway 120 but rather are carried by the flow of nitrogen gas (N₂) through the exit conduit 160 and then out into the ambient environment on its other end. The exit conduit 160 may include a restriction valve 162 to prevent back diffusion of gas within the exit conduit toward the ionization region 112. This is particularly important where the ionization region is maintained at or about atmospheric pressure. The gas within the exit conduit 160 may be at the same pressure (atmospheric) as the ionization region so a certain amount of back diffusion of gas molecules from the exit conduit toward the ionization region is possible. The exit conduit 160 need not be a separate passageway but may comprise openings, gaps or vents where gases can normally leak out of the chamber. In the latter case, flow restriction means would also be applied to restrict any back flow into the ionization chamber.

The embodiment of FIG. 2 may be particularly applicable for rapid analysis of forensic samples. For instance, during arson investigations, important forensic evidence often consists of wood samples taken from a burnt structure. From these samples, mass spectrometric analysis can be used to determine whether an accelerant or inflammable substance was applied to the wood, indicating the possibility of deliberate burning. Such a wood sample could be placed in a sample chamber and heated, allowing small concentrations of substances contained in the wood to be volatized and carried by the gas flow into the ionization region of the ion source apparatus. This process generally does not take a long time, since only a small amount of heat is required for wood (and many other substances) to release a sufficient amount of material for accurate detection of its constituents. In another technique for introducing gaseous neutrals, the neutrals are desorbed from beads, which can be made from alumina, titanium dioxide, silica gel or any other absorbent material. In this technique the desorption rate of gaseous neutrals from the beads can be controlled by slight differences in heat applied to the alumina beads due to the beads' high surface area. Accordingly, the front end of the detection process, sample preparation and ionization, can be performed easily and quickly, leaving more time for the analysis of detection results.

The ionization apparatuses discussed in FIGS. 1 and 2 can also be usefully applied for mass calibration purposes. Particularly when time-of-flight spectrometers are employed (as they often are in many applications due to their high sensitivity and infinite mass range) dynamic mass calibration is typically necessary because of slight dimensional changes that occur in the spectrometer flight tube. These changes affect the flight times of the ions within the flight tube and can alter the detection results. When a mass calibrant of known mass/charge ratio (which can also be referred to as a reference mass or lock mass) is ionized in conjunction with analytes, the detected mass/charge ratio of the mass calibrant can be used to determine a correction factor to compensate for changes in the flight tube length.

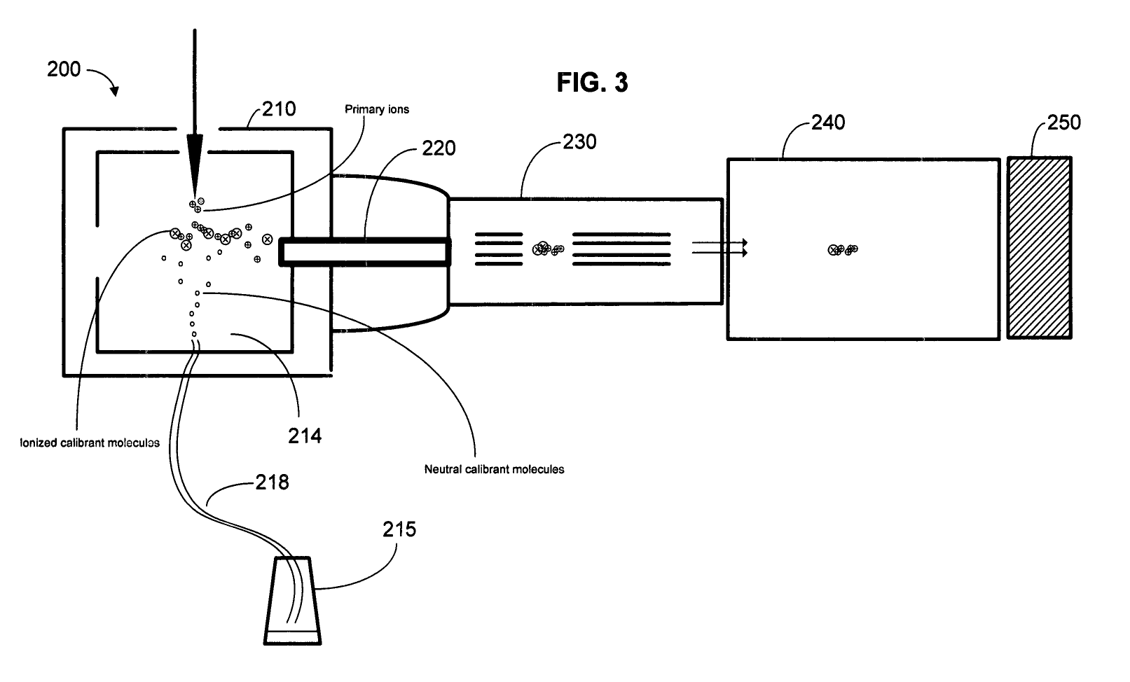

FIG. 3 illustrates an example mass spectrometer apparatus including an embodiment of an ion source according to the present invention with which mass calibration can be performed. The mass spectrometer 200 includes an ion source 210 (which may comprise the apparatus or be coupled to the apparatus described in FIG. 1 or FIG. 2) in which volatilized neutral molecules are ionized by charge transfer and/or other mechanisms by interaction with primary ions generated within the ionization region of the ion source. The primary ions may include analyte ions that are to be detected and identified. In the depicted application, the neutral molecules comprise mass calibrants which may be provided in a reservoir 215 as a vapor or enriched gas; the reservoir may be situated externally from the mass spectrometer 200 as shown. Calibrant molecules diffuse through a conduit 218 coupled on one end to the reservoir and emerge at the other end of the tube in the ionization apparatus 210. The volatized mass calibrant molecules emerge diffuse into the ionization region, and are then ionized by interaction with primary ions as described above.

This method of ionizing mass calibrant molecules within an ion source is easy to implement and does not require ionizing the mass calibrant molecules externally from the ion source or an additional ionization device, as is often provided in multimode ionization sources, because the mass calibrant ions are generated by interaction with the primary ions, rather than by an independent ionization mechanism.

The primary ions and the mass calibrant ions within the ionization region of the ion source 210 and are then guided by electrostatic forces along with the primary ions into a conduit 220 leading to the mass analyzer 240 via a transport region 230 which may include ion optics such as a multipole guide. The mass analyzer may comprise a TOF analyzer having a flight tube and other components such as an equalizer and a reflectron (both not shown). Packets of ions are released into the flight tube of a TOF analyzer in pulses; the kinetic energies of the ions are substantially equalized so that the flight times of different ion species through the chamber up to the detector 250 reflect the difference in their masses. The flight time of the mass calibrant is then used as a standard measurement for the correction of the detected flight times of the primary ions.

It is to be understood that the depiction of the molecules and ions herein is simplified for illustrative purposes and do not reflect their actual numbers and dimensions.

Having described the present invention with regard to specific embodiments, it is to be understood that the description is not meant to be limiting since further modifications and variations may be apparent or may suggest themselves to those skilled in the art. It is intended that the present invention cover all such modifications and variations as fall within the scope of the appended claims.

What is claimed is:

1. An apparatus for ionizing an analyte sample with a mass calibrant comprising:
an ionization chamber defining an ionization region;
a first passageway coupled to the ionization region for delivering the analyte sample to the ionization region;
a second passageway leading to a mass analyzer having an orifice arranged adjacent to the ionization region to receive ions from the ionization region;
a third passageway coupled to the ionization chamber at a first end and having a second end with an orifice arranged to receive gaseous neutral mass calibrant molecules; and
an ionization device arranged within the ionization chamber, the ionization device generating primary ions from the analyte sample, the primary ions ionizing a portion of the gaseous neutral mass calibrant molecules received into the ionization region via the third passageway.

2. The apparatus of claim 1, further comprising:
a first electrode arranged within the ionization chamber adjacent to the ionization region and opposite the second passageway, the electrode being maintained at an electric potential for directing the primary ions and ions generated from the mass calibrant molecules toward the orifice of the second passageway.

3. The apparatus of claim 2, further comprising:
a second electrode adjacent to the second passageway, the second electrode maintained at potential difference with respect to the first electrode for directing the primary ions and the ions generated from the mass calibrant molecules toward the orifice of the second passageway.

4. The apparatus of claim 1, wherein the ionization chamber is maintained at atmospheric pressure.

5. The apparatus of claim 1, further comprising:
an exhaust conduit that extends from the ionization chamber into the third passageway.

6. The apparatus of claim 1, further comprising:
an enclosure coupled to the third passageway for holding neutral mass calibrant molecules in a condensed phase; and
an exit conduit coupled to the ionization chamber, the exit conduit including a restriction valve.

7. An apparatus for ionizing molecules from a sample comprising:
an ionization chamber defining an ionization region;
a first passageway coupled to the ionization region for delivering a primary material to the ionization chamber;
a second passageway having an orifice arranged adjacent to the ionization region to receive ions from the ionization region;
a third passageway coupled to the ionization chamber at a first end and having a second end with an orifice arranged to receive gaseous neutral molecules derived from the sample; and
an ionization device arranged within the ionization chamber, the ionization device generating primary ions from the primary material provided via the first passageway to the ionization region, the primary ions ionizing a portion of the gaseous neutral molecules received into ionization region via the third passageway.

8. The apparatus of claim 7, further comprising:
a first electrode arranged within the ionization chamber adjacent to the ionization region and opposite the second passageway, the electrode being maintained at an electric potential for directing the primary ions and ions generated from the gaseous neutral molecules toward the orifice of the second passageway.

9. The apparatus of claim 8, further comprising:
a second electrode adjacent to the second passageway, the second electrode maintained at potential difference with respect to the first electrode for directing the primary ions and the ions generated from the gaseous neutral molecules toward the orifice of the second passageway.

10. The apparatus of claim 7, wherein the ionization chamber is maintained at atmospheric pressure.

11. The apparatus of claim 7, further comprising:
a sampling chamber for enclosing the sample coupled to the third passageway;

12. The apparatus of claim 11, further comprising:
a heating device situated adjacent to the sampling chamber for volatilizing molecules from the sample.

13. The apparatus of claim 7, wherein the secondary ions are generated by a process of charge transfer from the primary ions.

14. The apparatus of claim 7, further comprising:
an exhaust conduit coupled to the ionization chamber and arranged opposite from the third passageway for receiving exhaust gas flow from the ionization chamber.

15. The apparatus of claim 14, wherein the exhaust conduit includes a restriction valve adapted to reduce backward gaseous flow into the ionization chamber.

16. A mass spectrometry system for analyzing an analyte sample with a mass calibrant comprising:
an apparatus including:
an ionization chamber defining an ionization region;
a first passageway coupled to the ionization region for delivering the analyte sample to the ionization region
a second passageway leading to a mass analyzer having an orifice arranged adjacent to the ionization region to receive ions from the ionization region;
a third passageway coupled to the ionization chamber at a first end and having a second end with an orifice arranged to receive gaseous neutral mass calibrant molecules; and
an ionization device arranged within the ionization chamber, the ionization device generating primary ions from the analyze sample, the primary ions ionizing a portion of the gaseous neutral mass calibrant molecules received into the ionization region via the third passageway;
a mass analyzer coupled to the downstream end of the second passageway; and
a detector situated downstream from the mass analyzer.

17. The mass spectrometry system of claim 16, wherein the mass analyzer comprises a time-of-flight (TOF) analyzer.

18. The mass spectrometry system of claim 16, further comprising:
a sampling chamber coupled to the third passageway for holding neutral condensed-phase mass calibrant molecules.

19. The mass spectrometry system of claim 18, further comprising:
a heating device situated adjacent to the sampling chamber for volatilizing the mass calibrant molecules.

20. The mass spectrometry system of claim 16, further comprising:
an exhaust conduit coupled to the ionization chamber and arranged approximately opposite from the third passageway for receiving exhaust gas flow from the ionization chamber.

21. A method of ionizing molecules received from a sample situated external to an ion source, the method comprising:
providing primary ions in an ionization region within the ion source through a primary passageway; and
receiving gaseous neutral molecules from the external sample into the ionization region within the ion source via a secondary passageway, a portion of the gaseous neutral molecules from the external sample being ionized by interaction with the primary ions within the ionization region; and
guiding the primary ions and ions derived from the external sample to an inlet of a mass spectrometer.

22. The method of claim 21, further comprising:
heating the sample to volatilize molecules in the sample into a gaseous phase.

23. The method of claim 21, wherein the primary ions are generated by an electrospray process within the ion source.

24. The method of claim 21, wherein the primary ions comprise analyte ions and the neutral molecules of the external sample comprise a mass calibrant.

25. The method of claim 21, further comprising:
applying a low volume gas flow to facilitate movement of the gaseous neutral molecules from the sample into the ion source.

26. The method of claim 21, wherein the secondary passageway is exposed to an ambient environment and the gaseous neutral molecules from the sample diffuse into the ion source through the secondary passageway.

27. A method of calibrating a mass spectrometry system comprising:
providing analyte ions in an ionization region within the ion source;
receiving gaseous neutral mass calibrant molecules from a external source into the ionization region, a portion of the neutral mass calibrant molecules being ionized by interaction with the analyte ions produced in the ionization region;
directing both mass calibrant ions and analyte ions downstream into the mass analyzer; and
detecting the analyte ions and the mass calibrant ions in the mass analyzer.

28. The method of claim 27, wherein the mass analyzer comprises a time-of-flight (TOF) mass analyzer.

29. The method of claim 27, wherein the primary ions are generated by an electrospray process within the ion source.

30. An apparatus for providing a mass calibrant sample to an ion source having a first passageway for receiving an analyte sample, a second passageway leading downstream to a mass spectrometer and a third passageway for receiving a mass calibrant, the apparatus comprising:
a chamber having an opening for receiving a mass calibrant sample, a first orifice adapted to be coupled to the third passageway leading to the ion source and a second orifice adapted to be coupled to a source of gas flow; and
a restriction valve coupled to the first orifice of the chamber adapted to limit gas flow from the chamber toward the ion source.

31. The apparatus of claim 30, further comprising:
a heating device arranged adjacent to the chamber.
